(19) United States
(12) Patent Application Publication
(10) Pub. No.: US 2008/0299295 A1
(43) Pub. Date: Dec. 4, 2008

(54) RELIEF PRINTING PLATE AND PRINT

(75) Inventors: Hironori Kawakami, Tokyo (JP); Koji Takeshita, Tokyo (JP); Takahisa Shimizu, Tokyo (JP); Nahoko Inokuchi, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 11/859,619

(22) Filed: Sep. 21, 2007

(30) Foreign Application Priority Data
Sep. 21, 2006 (JP) 2006-255533

(51) Int. Cl. B05D 5/06; B41M 5/00

(52) U.S. Cl. 427/66; 428/195.1

(57) ABSTRACT

As finer patterns of relief printing plates are produced, the spacing between the convex portions of the relief printing plates decreases, and a sufficient relief depth, which is the depth of a concave portions between the convex portions, cannot be obtained. In one embodiment of the present invention, there is provided a relief printing plate for use when a coating liquid is supplied to convex portions of the relief printing plate, the coating liquid located on the convex portions is printed, and a pattern composed of the coating liquid is formed on the print surface, this relief printing plate comprising a metal support having convex portions and a resin layer disposed on the convex portions of the support.

### CROSS REFERENCE

This application claims priority to Japanese application Number 2006-255533, filed on Sep. 21, 2006, which is incorporated by reference.

### BACKGROUND OF THE INVENTION

1. Field of the Invention

The present invention relates to a relief printing plate for use in a relief printing method and to a print manufactured by the relief printing method. An organic electroluminescence element (referred to hereinbelow as organic EL element) is an example of such a print, and an organic light-emitting layer of the organic EL element is formed by the relief printing method. In addition to the organic EL element, other examples of such prints include color filters, circuit substrates, thin-film transistors, microlenses, and biochips.

2. Description of the Related Art

For example, in an organic EL element, an organic light-emitting layer comprising an organic light-emitting material is formed between a pair of opposing electrodes and light emission is induced by passing an electric current to the organic light-emitting layer. In order to emit light with good efficiency, the thickness of the light-emitting layer plays an important role and the layer has to be formed as a thin film with a thickness of about 100 nm. Further, it has to be patterned with high accuracy to produce a display.

Organic light-emitting materials can be low-molecular materials and high-molecular materials. The low-molecular materials are generally formed as a thin film by a resistance heating vapor deposition method or the like, and in this process patterning is performed by using a finely patterned mask. However, the problem associated with this method is that the larger is the size of the substrate the more difficult it is to ensure a high patterning accuracy.

Accordingly, an attempt has recently been made to use a high-molecular material for the organic light-emitting material, dissolve the organic light-emitting material in a solvent to obtain a coating liquid, and form a thin film by a wet coating method using the coating liquid. A spin coating method, a bar coating method, an ejection coating method, and a dip coating method are known as wet coating methods for forming thin films, but these methods are difficult to use for patterning with high accuracy or color-separated RGB colors, and thin film formation by a printing method that excels in color-separated patterning appears to be most effective.

Because glass substrates are most often used as substrates for organic EL elements and displays, those printing methods that use a hard plate such as a metal printing plate as in a gravure printing method are unsuitable, and an offset printing method that uses an elastic rubber plate and a relief printing method using a photosensitive resin plate comprising a rubber or other resins as the main component are preferred. A method based on offset printing (JP-A-2001-93668) and a method based on relief printing (JP-A-2001-155858) have been actually suggested as implementations of the printing methods.

As the accuracy of organic EL elements increases, finer patterns become necessary also for relief printing plates that are used for pattern formation by the relief printing method. Organic light-emitting materials have poor solubility in water and alcohol-based solvents, and they have to be dissolved or dispersed using an organic solvent to obtain a coating liquid. A rubber or a resin is the main component of the relief printing plate used in the relief printing method, and organic solvents easily cause swelling or deformation of this component, thereby causing displacement during printing and making it impossible to obtain a pattern with a high positional accuracy.

Further, as finer patterns of relief printing plates are produced, spacing between the convex portions of the relief printing plates decreases, and a sufficient relief depth, which is the depth of a concave portions between the convex portions, cannot be obtained. Further, a problem arising when pattern formation is performed using a relief printing plate that does not have a sufficient relief depth is that the ink flows into the relief when the ink is supplied to the relief printing plate, whereby the pattern spreads and a fine pattern cannot be obtained.

### SUMMARY OF THE INVENTION

As finer patterns of relief printing plates are produced, the spacing between the convex portions of the relief printing plates decreases, and a sufficient relief depth, which is the depth of a concave portions between the convex portions, cannot be obtained. In one embodiment of the present invention, there is provided a relief printing plate for use when a coating liquid is supplied to convex portions of the relief printing plate, the coating liquid located on the convex portions is printed, and a pattern composed of the coating liquid is formed on the print surface, this relief printing plate comprising a metal support having convex portions and a resin layer disposed on the convex portions of the support.

### BRIEF DESCRIPTION OF THE DRAWINGS

FIG. 1 is a cross-sectional view of the relief printing plate in accordance with the present invention.

FIG. 2 is a cross-sectional view of the relief printing plate in accordance with the present invention.

FIG. 3 is a cross-sectional view of the relief printing plate in accordance with the present invention.

FIG. 4 is a schematic drawing or a print manufacturing apparatus using the relief printing plate in accordance with the present invention.

FIG. 5 is a cross-sectional view of a light-emitting unit of an organic EL element.

FIG. 6 is a cross-sectional view of the relief printing plate in accordance with the present invention.

FIGS. 7A, 7B, 7C, 7D, 7E, and 7F are process diagrams illustrating a method for forming the relief printing plate in accordance with the present invention.

### DESCRIPTION OF THE PREFERRED EMBODIMENTS

The embodiments of the present invention will be described below. The print in accordance with the present invention can be advantageously used as an optical component constituting a display screen of a display. An organic EL element is an example of such optical component, and a color filter constituting a color liquid crystal display is another example thereof. Other examples of prints in accordance with the present invention include circuit substrates, thin-film transistors, microlenses, and biochips.

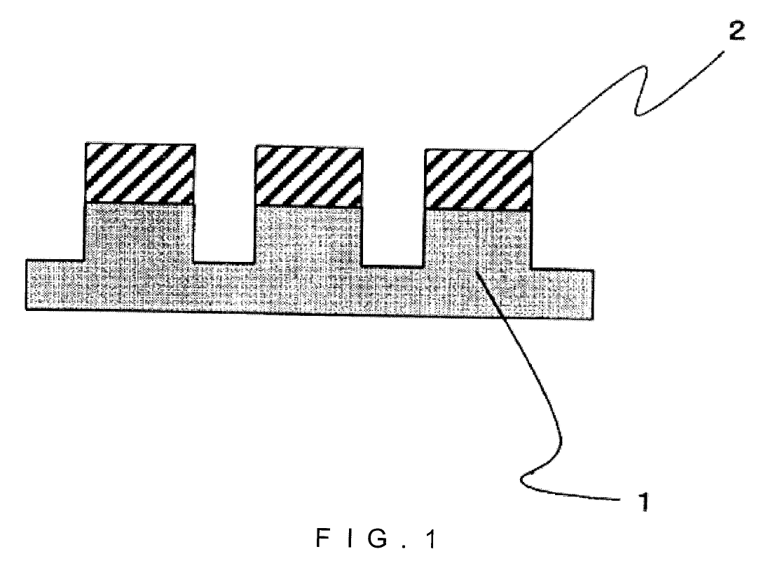

FIG. 1 is a cross-sectional view of the relief printing plate of the present embodiment. In FIG. 1, the reference symbol 1 stands for a support having convex portions, 2—a resin layer.

A metal can be used as the support 1 having convex portions (referred to hereinbelow as “support”). By using a metal it is possible to obtain a plate with high dimensional stability because the entire support will not swell under the effect of solvent contained in the coating liquid. Examples of suitable metals include Fe, Ni, Cu, and Zn. Alloys of these metals such as stainless steel may be also used.

It is preferred that the size of convex portions in the support having convex portions be larger than the size of the resin layer 2. Where the convex portions are larger in size than the resin layer, processing of the convex portions of the support is facilitated.

The resin layer 2 may be of any kind, provided that it demonstrates resistance to the solvent of the ink used, and at least one material for the layer can be selected from rubbers such as nitrile rubber, silicone rubber, isoprene rubber, styrene-butadiene rubber, butadiene rubber, chloroprene rubber, butyl rubber, acrylonitrile rubber, ethylene propylene rubber, and urethane rubber, synthetic resins such as polyethylene, polystyrene, polybutadiene, poly(vinyl chloride), poly(vinylidene chloride), poly(vinyl acetate), polyamides, polyethersulfones, polyethylene terephthalate, polyethylene naphthalate, polyethersulfones, and poly(vinyl alcohol), copolymers thereof, natural macromolecular compounds such as cellulose, and fluororesins such as fluorine-containing elastomers, polytetrafluoroethylene, polyvinylidene fluoride, polytetrafluorovinylidene, and copolymers thereof. From the standpoint of processability, it is preferred that a photosensitive resin be used.

Where an organic solvent is used as the coating liquid, a photosensitive resin of a water development type that also has high resistance to organic solvents can be advantageously used. Any well-known photosensitive resin of a water development type can be used, for example, a resin of a type comprising a hydrophilic polymer, amonomer having unsaturated bonds, and a photopolymerization initiator can be used. In the resins of this type, polyamides, poly(vinyl alcohol), and cellulose derivatives can be used as the hydrophilic polymer. Methacrylates having vinyl bonds can be used as the monomers having unsaturated bonds, and for example aromatic carbonyl compounds can be used as the photopolymerization initiator. Among them, from the standpoint of suitability for printing, polyamide photosensitive resins of a water development type are preferred.

The thickness of the resin layer is preferably 1 μm or more and 1 mm or less. Where the thickness is less than 1 μm, when the printing substrate is from a hard material such as glass or a metal, the printing substrate or a pattern located on the printing substrate is sometimes damaged. Where the thickness is more than 1 mm, dynamic deformation or fracture occurs close to be boundary of the support and the resin layer or in the resin layer. Further, the degree of swelling of the resin layer that is induced by solvent increases.

A relief depth, which is a depth of concave portions between convex portions, in the configuration in which the support 1 having convex portions is combined with the resin layer is preferably 10 μm or more and 1.5 mm or less. Where the relief depth is less than 10 μm, certain pattern shapes can be widened. Further, when the relief depth exceeds 1.5 mm, deformation or fracture occurs in the support, in particular in the convex portions of the support.

The relief printing plate in accordance with the present invention can be manufactured by forming convex portions on a support and then forming a resin layer on the convex portions of the support, or by providing a resin layer on a support and then processing the resin layer and the support simultaneously. The convex portions can be formed on the support by a metal etching method. The convex portions can be also formed by laser ablation or by cutting. When a photosensitive resin is used for the resin layer, the convex portions can be formed by exposure and development. Screen printing or offset printing can be also used. Formation by laser ablation and cutting is also possible. Where the resin layer and the support are processed simultaneously, the convex portions can be formed by laser ablation, cutting, or the like.

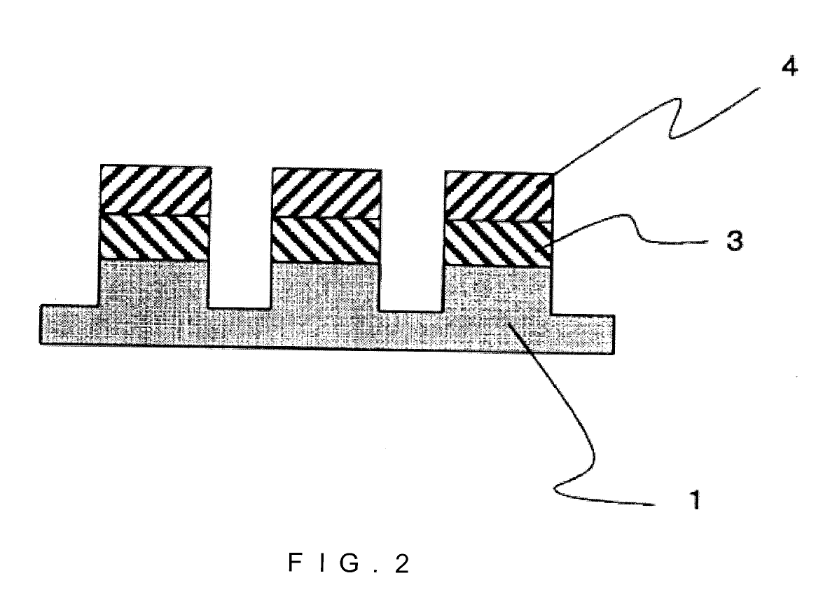

FIG. 2 shows another embodiment of the present invention. According to this embodiment, the resin layer can have a multilayer configuration rather than a monolayer configuration. In the case illustrated by FIG. 2, it is preferred that a resin layer 4 having flexibility and a resin layer 3 having resistance to solvents be formed in the order of description from the support side. These layers can be formed from the same materials that are described above as suitable for the formation of resin layer. A sponge-like structure obtained by forming gas bubbles in the resin layer 4 having flexibility may be also used. The sponge may have isolated or continuous gas bubbles. Where the resin layer having flexibility is provided, even when a high pressure is applied during printing, a printing substrate or a pattern present on the printing substrate can be prevented from damage where the printing substrate is made from a hard material such as glass or metal.

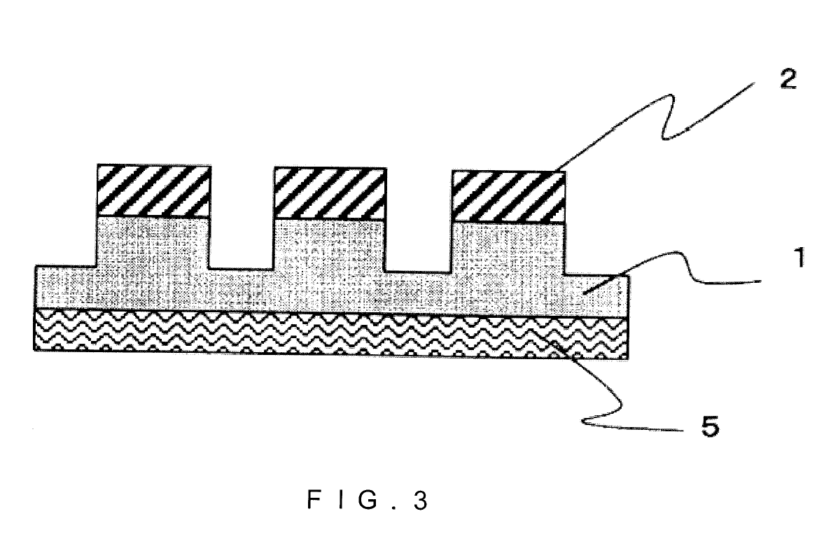

Yet another embodiment is shown in FIG. 3. As shown in FIG. 3, a cushion layer 5 having flexibility can be provided on the surface opposite that of the convex portions of the support. A well-known elastic rubber or foamed material can be used for the cushion layer 5. Where the cushion material is provided, even when a high pressure is applied during printing, a printing substrate or a pattern present on the printing substrate can be prevented from damage where the printing substrate is made from a hard material such as glass or metal, in the same manner as in the case where a resin layer having flexibility is provided.

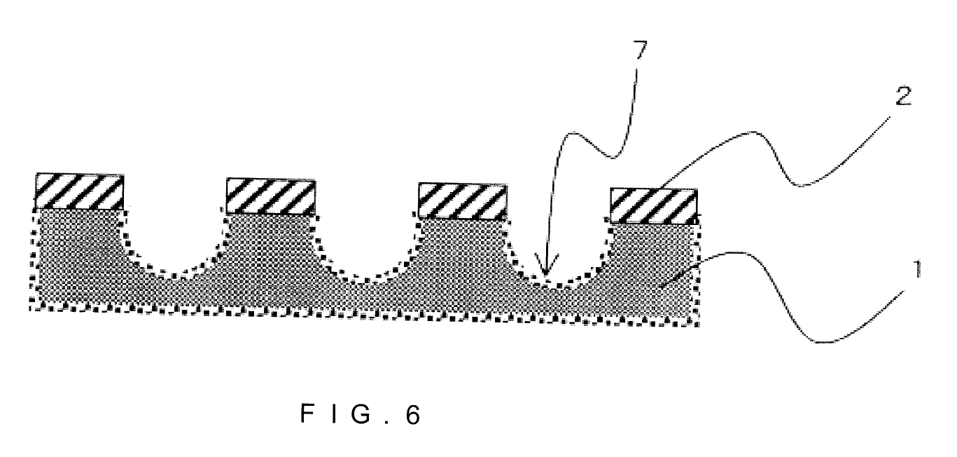

FIG. 6 shows an example of embodiment of the relief printing plate in which the support surface is subjected to processing. A resin layer 2 is disposed on the convex portions of a support 1 having convex portions, and a layer 7 comprising at least fluorine atoms is provided on the support surface where the resin layer 2 is not disposed. By forming a layer comprising at least fluorine atoms on the surface of metal support, it is possible to impart excellent weather resistance, resistance to contamination, and water repellency to the support.

The layer 7 comprising fluorine atoms can be formed by preparing a coating liquid containing a polymer comprising fluorine atoms and a silane coupling agent and coating the liquid by a well-known wet coating method such as a bar coating method, an ejection coating method, a dip coating method, a die coating method, a slit coating method, and a spray coating method. An electrodeposition method can be also used. The electrodeposition method is especially preferred because a uniform layer can be formed on the metal support surface. For example, a method described in specification of Japanese Patent No. 3001316 can be used as an electrodeposition method.

The layer comprising fluorine atoms that is formed on the support surface may be formed from fluorine-containing elastomers or a fluororesin such as polytetrafluoroethylene, polyfluorovinylidene, and polyhexafluorovinylidene, and copolymers thereof.

In particular, when surface treatment is performed by an electrodeposition method, any resin comprising at least fluorine atoms may be used, specific examples including fluoroethylene—vinyl ether copolymer, fluoroethylene—vinyl ether—vinyl ester copolymer, and fluoroethylene—vinyl ether—allyl ether—vinyl ester copolymer.

A compound marketed by Asahi Glass Co., Ltd. under a trade name Lumiflon 926 can be used as the fluoroethylene—vinyl ether copolymer. Compounds marketed by Central Glass Co., Ltd. under trade names Cefral Coat XA-5000-2 and Cefral Coat XA-500-3 can be used as the fluoroethylene—vinyl ether—allyl ether—vinyl ester copolymers. Further, Coatax FX-300 is marketed by Toray Industries, Inc. as a compound in which a fluororesin is bonded to a side chain of an acrylic resin.

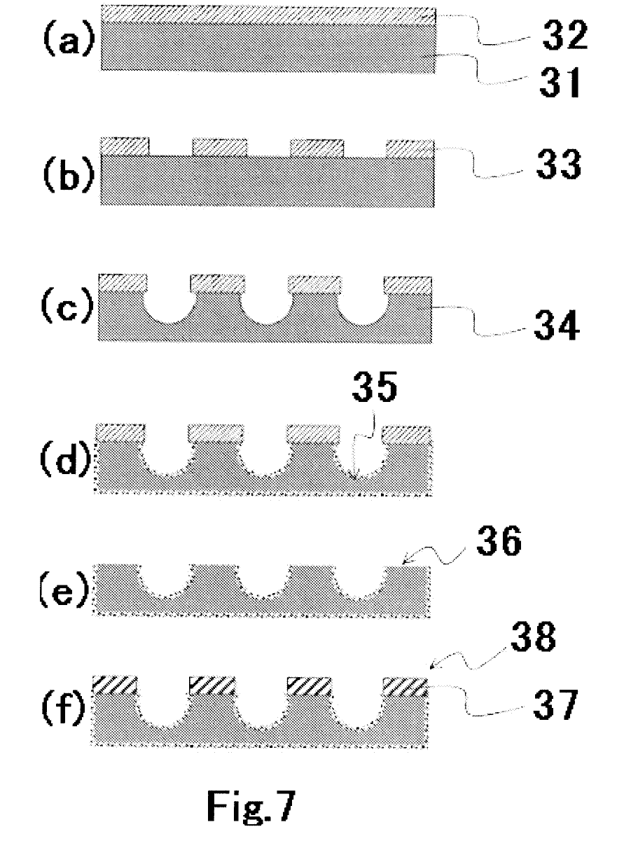

FIG. 7 illustrates an example of a process for producing a relief printing plate in which a layer comprising fluorine atoms is formed on the surface of a support having convex portions. As a first step, a photosensitive resin material 32 serving as an etching resist is laminated on the surface of a metal sheet 31 serving as a support (FIG. 7A). A typical positive or negative liquid resist can be used as the photosensitive resin material and coated, e.g., by a spin coating method. Alternatively, a film-shaped photosensitive resin material can be used as a laminate. It is generally preferred that a photosensitive resin called a dry film resist be laminated on the surface of a metal sheet serving as a support, this method being both simple and easy to implement.

Examples of dry film resists that can be used include Sun Photo Series manufactured by Asahi Kasei Electronics KK, Listen Series manufactured by Du Pont MRC Dry Film Co., Ltd., and Photec Series manufactured by Hitachi Chemical Co., Ltd.

As a second step, this photosensitive resin material is exposed to irradiation with active optical radiation such as ultraviolet radiation. Development is then performed using an alkaline aqueous solution or the like and a resist pattern 33 is formed that covers portions that will be convex portions in the relief printing plate obtained (FIG. 7B).

As a third step, the metal plate that is not coated with the resist pattern 33 is etched out by an etching process and a support 34 having convex portions is formed (FIG. 7C). For example, an aqueous solution of ferric chloride is used as the etching solution.

As a fourth step, the metal support that has not been coated with the resist pattern by the above-described electrodeposition or coating method is surface treated and a layer 35 comprising at least fluorine atoms is formed (FIG. 7D).

As a fifth step, the resist pattern is stripped off (FIG. 7E). Only the surface 36 of convex portions that was coated with the resist pattern is not surface treated and metal surface is exposed.

As a sixth step, a resin material that is resistant or adapted to the ink to be used for printing is coated on the surface 36 of convex portions formed on the metal support, and a resin layer 37 is formed. More specifically, a photosensitive resin material is used and coated on the entire surface of the support, and then exposure and development are conducted so that only the portion corresponding to the surface of convex portions is cured, and a resin layer is formed only on the surface of convex portions.

A target relief printing plate 38 can be thus manufactured (FIG. 7F).

With this method, a resin layer can be formed on the surface of convex portions with good efficiency, and a layer comprising at least fluorine atoms can be formed on the support surface where the resin layer is absent. In particular, because the resist pattern is stripped off after the support has been surface treated and the resin layer is then again laminated, modification of the resin layer is prevented and good affinity for ink can be ensured.

Here, when the resist used for etching the support and a support serving as a relief plate are themselves resistance to the ink to be used during printing, the plate obtained upon completion of etching of the third step can be used, without stripping off the resist, as a relief printing plate of another embodiment of the present invention.

When continuous printing is conducted for a long time, corrosion of metal components (support) caused by the ink penetration into the relief and changes in ambient environment becomes a matter of concern. Therefore, it is preferred that surface treatment be conducted to impart weather resistance to the metal support, that is, that a layer comprising at least fluorine atoms be formed.

Further, the relief printing plate in accordance with the present invention is preferably a seamless plate. A seamless plate is a cylindrical printing plate in which convex portions are continuously formed on the circumferential surface and which has no seams. As a result, continuous rotation of the plate is possible and continuous printing can be performed. Therefore, prints having repetitive patterns of a large surface area can be obtained without increasing the diameter of the cylindrical printing plate. In the field of display devices, the screens have been increasing in size, but using seamless printing plates makes it possible to obtain organic EL elements or color filters of large surface area, without increasing the size of a printing apparatus.

Further, the relief printing plate in accordance with the present invention preferably has a sleeve structure. The “sleeve structure” means a cylindrical structure. With a cylindrical structure, the relief printing plate can be fixed by inserting into a cylinder having an outer diameter equal to the inner diameter of cylindrical plate. With the relief printing plate in accordance with the present invention, the process of forming the printing plate and the printing process have to be implemented using different apparatuses, but assembling and disassembling are facilitated by using the sleeve structure.

A method for producing a print by using the relief printing plate in accordance with the present invention will be described below.

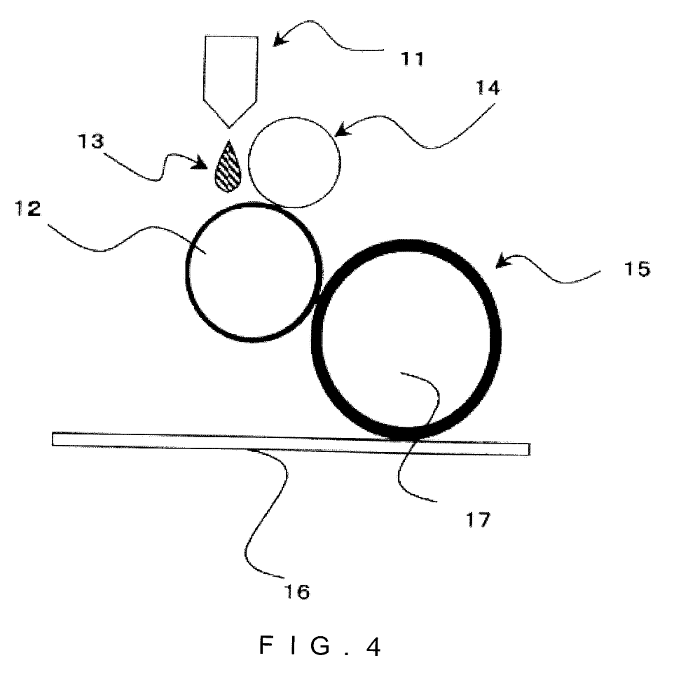

FIG. 4 is a schematic drawing of a print manufacturing apparatus using the relief printing plate. For example, as shown in FIG. 4, a coating liquid 13 is supplied from an ink supply device 11 to an anilox roll 12 that is a device for inking a relief printing plate, and an excess portion of the coating liquid 13 supplied to the anilox roll 12 can be removed with a doctor device 14. In addition to a dropping-type supply device, a fountain roll or a coater such as a slit coater, a die coater, and a cap coater or a combination thereof can be used for the ink supply device. A doctor roll or a doctor blade can be used as the doctor device 14.

After the excess coating liquid has been removed with the doctor device 14, inking is performed on a relief printing plate 15 of the present invention. The ink that was inked on the relief printing plate 15 located on the outer periphery of a cylinder 17 is printed on a printing substrate 16. The present invention is not concerned with the material of the printing substrate, and paper, plastic films, glass, and metals can be used. The coating liquid 13 printed on the printing substrate 16 forms a print. If necessary, drying is performed.

A process for manufacturing an organic EL element using the relief printing plate in accordance with the present invention will be described below.

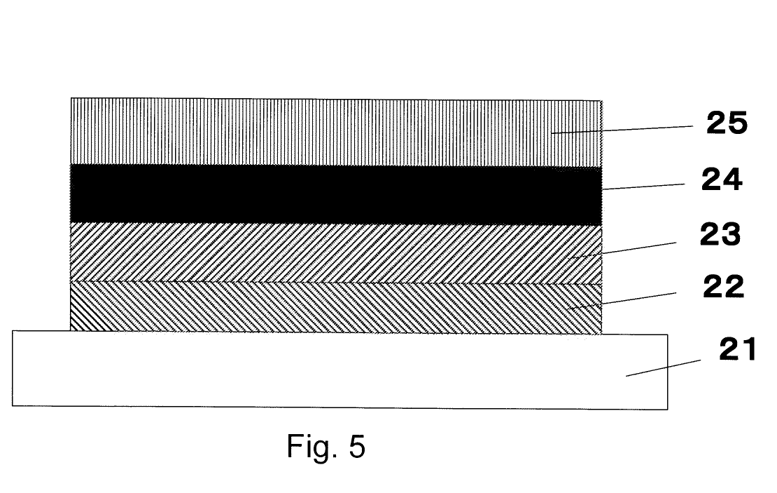

FIG. 5 is a cross-sectional view illustrating a light-emitting unit of an organic EL element. In the light-emitting unit of the organic EL element, a hole injection layer 23 that is an organic light-emitting medium layer and an organic light-emitting layer 24 are disposed between a substrate 21, a first electrode 22, and a second electrode 25. The hole injection layer shown in FIG. 5 or a hole transport layer, an electron injection layer, and an electron transport layer can be appropriately selected and provided.

In the unit of the organic EL element, a glass substrate or a plastic film or sheet can be used as the substrate 21. Where the plastic film is used, the organic light-emitting elements can be manufactured by a winding process and the elements can be provided at a low cost. Examples of suitable plastics include polyethylene terephthalate, polypropylene, cycloolefin polymers, polyamides, polyethersulfones, polymethyl methacrylate, and polycarbonates. Further, a gas barrier film such as a ceramic-deposited film, polyvinylidene chloride, polyvinyl chloride, or saponified ethylene—vinyl acetate copolymer may be laminated on the side where the first electrode 22 is not formed.

The first electrode is then formed. The first electrode 22 and second electrode 25 function as an anode and a cathode and are appropriately selected according to the light take-out direction and the like. A complex oxide of indium and tin (referred to hereinbelow as ITO) is used as the anode material. A semi transparent film obtained by depositing a metal such as aluminum, gold, or silver, or an organic compound such as polyaniline can be also used. Examples of suitable cathode materials include metals such lithium, magnesium, calcium, ytterbium, and aluminum, oxides, and alloys thereof with stable metals such as gold and silver. Further, conductive oxides of indium, zinc, and tin can be also used. The first electrode and second electrode can be formed by the usual dry film forming methods, for example, vacuum deposition, sputtering, ion plating, and ion beam deposition.

Examples of materials suitable for the hole injection layer 23 include conductive polymer materials such as polyaniline derivatives, polythiophene derivatives, polyvinyl carbazole derivatives, a mixture of poly(3,4-ethylenedioxythiophene) with polystyrenesulfonic acid. The hole injection layer is formed by dissolving or dispersing in a solvent such as water or an alcohol, and coating by a coating method such as spin coating, die coating, or spraying, or a printing method such as relief printing, ink jet printing, screen printing, or offset printing. The relief plate can be also formed by using the relief printing plate in accordance with the present invention.

The organic light-emitting layer 24 is a layer comprising an organic light-emitting material that emits light under applied voltage. Examples of suitable organic light-emitting materials include organic light-emitting materials that are soluble in organic solvents, such as materials of coumarin system, perylene system, pyran system, anthrone system, porphyrin system, quinacridone system, N,N′-dialkyl-substituted quinacridone system, naphthalimide system, N,N′-diaryl-substituted pyrrolopyrrole system, and iridium complexes, dispersions of these organic light-emitting materials in polymers such as polystyrene, polymethyl methacrylate, and polyvinyl carbazole, and polymeric organic light-emitting materials of polyarylene system, polyarylene vinylene system, and polyfluorene system.

In the manufacturing process using the configuration shown in FIG. 4 in accordance with the present invention, a printing substrate obtained by laminating the first electrode 22 and hole injection layer 23 on the substrate 21 is used as the printing substrate 16, and a coating liquid comprising an organic light-emitting material is used as the coating liquid 13.

The coating liquid comprising the organic light-emitting material is supplied, as described hereinabove, to convex portions of a relief printing plate and printing is performed on the aforementioned printing substrate. Examples of solvents for use in the coating liquid that serve to dissolve or disperse the light-emitting material include toluene, xylene, acetone, methyl ethyl ketone, methyl isobutyl ketone, cyclohexanone, methanol, ethanol, isopropyl alcohol, ethyl acetate, butyl acetate, chloroform, methylene chloride, dichloroethane, trichloroethane, tetrachloroethane, and water, or mixtures thereof. In particular, aromatic solvents and halogen-containing solvents excel in dissolving organic light-emitting materials. A surfactant, an antioxidant, a viscosity adjusting agent, a UV absorbent, or a drying agent may be added, if necessary, to the coating liquid comprising an organic light-emitting material. The second electrode is formed by the above-described method after the organic light-emitting layer is formed.

In accordance with the present invention, a relief printing plate can be obtained without swelling or deformation in the solvent of the coating liquid, with a sufficient relief depth, and without penetration of coating liquid into the concave portions. Further, the relief printing plate has high corrosion resistance and disturbance of the printing pattern by the penetration of coating liquid into the concave portions can be prevented more effectively. Therefore, a highly accurate print having good positional accuracy and a fine pattern can be obtained.

In particular, when an organic light-emitting medium layer in an organic EL element is formed by using the relief printing plate in accordance with the present invention, an organic light-emitting element having a fine pattern can be obtained.

### Example 1

Manufacture of an organic EL element as a print will be described below in greater detail as an example of the present invention.

The spread of brightness was evaluated according to “Method for Measuring Organic EL Display Modules (Established in April 2005)” of Japan Electronics and Information Technology Industries Association Standards (JEITA).

### <Preparation of Coating Liquid for Forming an Organic Light-Emitting Layer>

A light-emitting material comprising a poly(paraphenylene vinylene) derivative was dissolved in xylene to a coating liquid concentration of 1.0 wt. % to prepare a coating liquid for forming a light-emitting layer.

### <Fabrication of Printing Substrate>

A poly(3,4)ethylenedioxythiophene/polystyrenesulfonic acid (PEDOT/PSS) film with a thickness of 100 nm was formed as a hole transport layer by using a spin coater on a substrate (manufactured by Geomatec Co., Ltd.) in which an ITO film with a surface resistance of 15Ω was formed on a square glass substrate with a thickness of 0.4 mm and a side length of 150 mm. A printing substrate was then fabricated by drying the formed PEDOT/PSS thin film for 1 hr at 100° C. under reduced pressure.

### <Printing of the Coating Liquid for a Light-Emitting Layer>

A mirror-finished steel sheet with a thickness of 0.3 mm was processed by etching to obtain a convex portion width of 100 μm, a concave portion width of 400 μm, and a relief depth of 30 μm. A sheet-like printing plate was fabricated by coating a polyamide photosensitive resin on the entire surface of the steel sheet to obtain a thickness of the resin layer on the convex portions of 10 μm. The sheet-like printing plate was laminated with a photomask fabricated by depositing chromium on a quartz plate, alignment was performed using a CCD camera, and exposure with ultraviolet radiation was performed. Upon completion of exposure, development was performed using a liquid developer, and a relief printing plate with a relief depth of 40 μm was fabricated.

This relief printing plate and the above-described coating liquid for forming a light-emitting layer were used for obtain a print on the printing substrate with a relief printing machine. The positional accuracy of the printed pattern was within ±2 μm. After the light-emitting layer has been printed, drying was carried out for 1 hr at 130° C. After drying, calcium was coated to a thickness of 10 nm on the light-emitting layer formed by printing, and then silver was vacuum deposited thereupon to a thickness of 300 nm to fabricate an organic EL element.

Light emission characteristic of the organic EL element at 5 V was observed. Light emission with a brightness spread of 3σ=±11 cd/m² with respect to an average brightness μ=108 cd/m² of the light-emitting surface was obtained.

### Example 2

An urethane resin layer with a thickness of 10 μm and a polyamide resin layer with a thickness of 10 μm were formed on the surface of mirror-finished steel sheet with a thickness of 0.3 mm, laser irradiation was performed from the resin layer side by using a laser ablation method, the processing was carried out to obtain a convex portion width of 100 μm, a concave portion width of 400 μm, and a relief depth of 40 μm, and the steel sheet was fixed to a cylinder of an in-house printing machine with a two-side adhesive tape. The relief printing plate thus obtained and the above-described coating liquid for forming a light-emitting layer were used to conduct printing on the printing substrate. The positional accuracy of the printed pattern was within ±2 μm. After the light-emitting layer has been printed, drying was carried out for 1 hr at 130° C. After drying, calcium was coated to a thickness of 10 nm on the light-emitting layer formed by printing, and then silver was vacuum deposited thereupon to a thickness of 300 nm to fabricate an organic EL element.

Light emission characteristic of the organic EL element at 5 V was observed. Light emission with a brightness spread of 3σ=±18 cd/m² with respect to an average brightness μ=103 cd/m² of the light-emitting surface was obtained.

### Example 3

A polyamide resin layer with a thickness of 10 μm was formed on the surface of a mirror-finished steel sheet with a thickness of 0.3 mm, laser irradiation was performed from the resin layer side by using a laser ablation method, the processing was carried out to obtain a convex portion width of 100 μm, a concave portion width of 400 μm, and a relief depth of 40 μm, and the steel sheet was fixed to a cylinder of an in-house printing machine with a sponge-like two-side adhesive tape. The relief printing plate thus obtained and the above-described coating liquid for forming a light-emitting layer were used to conduct printing on the printing substrate. The positional accuracy of the printed pattern was within ±2 μm.

After the light-emitting layer has been printed, drying was carried out for 1 hr at 130° C. After drying, calcium was coated to a thickness of 10 nm on the light-emitting layer formed by printing, and then silver was vacuum deposited thereupon to a thickness of 300 nm to fabricate an organic EL element.

Light emission characteristic of the organic EL element at 5 V was observed. Light emission with a brightness spread of 3σ=±17 cd/m² with respect to an average brightness μ=102 cd/m² of the light-emitting surface was obtained.

### Example 4

A solvent-resistant resin layer with a thickness of 10 μm was formed on the surface of a mirror-finished iron cylinder with an inner diameter of 15 cm, and a seamless relief printing plate with a convex portion width of 100 μm, a concave portion width of 400 μm, and a relief depth of 40 μm was obtained by a laser ablation method. The relief printing plate thus obtained and the above-described coating liquid for forming a light-emitting layer were used to conduct printing on the printing substrate with a relief printing machine. The cylindrical relief printing plate was fixed to a cylinder having an outer diameter equal to the inner diameter of the cylinder. The positional accuracy of the printed pattern was within ±2 μm.

After the light-emitting layer has been printed, drying was carried out for 1 hr at 130° C. After drying, calcium was coated to a thickness of 10 nm on the light-emitting layer formed by printing, and then silver was vacuum deposited thereupon to a thickness of 300 nm to fabricate an organic EL element.

Light emission characteristic of the organic EL element at 5 V was observed. Light emission with a brightness spread of 3σ=±17 cd/m² with respect to an average brightness μ=111 cd/m² of the light-emitting surface was obtained.

### Example 5

A dry film resist Photec RY-3315EE manufactured by Hitachi Chemical Co., Ltd. was laminated on one surface of a mirror-finished steel sheet with a thickness of 0.3 mm, and a line-shaped patter with a line width 100 μm and a space width of 400 μm was formed by exposure and development. Exposure was performed by illumination at 250 mJ/cm² by using an exposure device HMW-532D manufactured by ORC Co., Ltd., and the development was performed by spraying an aqueous solution of sodium carbonate.

Then, etching was performed for 5 min by a dipping method using an aqueous solution of ferric chloride, and a support having a relief with a convex portion width of 100 μm, a concave portion with of 400 μm, and a relief depth of 30 μm was obtained. At this stage, the etching resist still adhered to the relief surface. Electrodeposition was then performed by using a fluorine-containing electrodeposition paint, and the support surface that had not been covered with the resist was coated.

The resist pattern was stripped off by spraying an aqueous solution of sodium hydroxide, and negative-type photosensitive polyamide resin was then coated over the entire surface of the relief formation surface of the support that was subjected to such surface treatment in order to form a resin layer with a thickness of 10 μm. The sheet-like printing plate with the resin layer formed thereon was laminated with a photomask fabricated by depositing chromium on a quartz plate, alignment was performed using a CCD camera, and exposure with ultraviolet radiation was conducted. The photomask was designed such as to expose and cure a portion corresponding to the surface of the relief printing plate. When development was carried out using a liquid developer after the exposure, a relief printing plate having a relief depth of 40 μm and comprising a resin layer with a thickness of 10 μm on the surface of the convex portions was fabricated. A layer comprising fluorine atoms was formed on the portion of the support where no resin layer was formed. This relief printing plate and the above-described coating liquid for forming a light-emitting layer were used to conduct printing on the printing substrate with a relief printing machine. The relief printing plate was used upon fixing to a cylinder to obtain a cylindrical shape. The positional accuracy of the printed pattern was within ±2 μm.

After the light-emitting layer has been printed, drying was carried out for 1 hr at 130° C. After drying, calcium was coated to a thickness of 10 nm on the light-emitting layer formed by printing, and then silver was vacuum deposited thereupon to a thickness of 300 nm to fabricate an organic EL element.

Light emission characteristic of the organic EL element at 5 V was observed. Light emission with a brightness spread of 3σ=±5 cd/m² with respect to an average brightness μ=125 cd/m² of the light-emitting surface was obtained.

### Comparative Example 1

A polyamide photosensitive resin was coated on a PET film with a thickness of 0.1 mm, and a sheet-like printing plate was fabricated to obtain a resin layer thickness of 50 μm. The sheet-like printing plate was laminated with a photomask fabricated by depositing chromium on a quartz plate, alignment was conducted using a CCD camera, and exposure with ultraviolet radiation was performed. When development was carried out using a liquid developer after the exposure, a resin relief printing plate having a relief depth of 30 μm could be fabricated.

This relief printing plate and the above-described coating liquid for forming a light-emitting layer were used to conduct printing on the printing substrate with a relief printing machine. The positional accuracy of the printed pattern was within ±40 μm and a sufficient printing accuracy could not be obtained.

### Reference Example 1

A mirror-finished steel sheet with a thickness of 0.3 mm was processed by etching to obtain a convex portion width of 100 μm, a concave portion width of 400 μm, and a relief depth of 30 μm. A sheet-like printing plate was fabricated by coating a polyamide photosensitive resin on the entire surface of the steel sheet to obtain a thickness of the resin layer on the convex portions of 0.5 μm. The sheet-like printing plate was laminated with a photomask fabricated by depositing chromium on a quartz plate, alignment was conducted using a CCD camera, and exposure with ultraviolet radiation was performed. Upon completion of exposure, development was performed using a liquid developer, and a relief printing plate with a relief depth of 30.5 μm was fabricated.

This relief printing plate and the above-described coating liquid for forming a light-emitting layer were used to obtain a print on the printing substrate with a relief printing machine. The positional accuracy of the printed pattern was within ±2 μm. After the light-emitting layer has been printed, drying was carried out for 1 hr at 130° C. After drying, calcium was coated to a thickness of 10 nm on the light-emitting layer formed by printing, and then silver was vacuum deposited thereupon to a thickness of 300 nm to fabricate an organic EL element. Light emission characteristic of the organic EL element was observed, and uniform light emission was obtained over the entire surface within the pattern zone. However, it was observed that cracks locally appeared in the glass substrate.

What is claimed is:

1. A relief printing plate comprising:
a metal support having convex portions and concave portions; and
a resin layer disposed on said concave portions of said support.

2. The relief printing plate according to claim 1, wherein
a thickness of said resin layer is 1 μm or more and 1 mm or less.

3. The relief printing plate according to claim 1, wherein
the relief depth of said relief printing plate is 10 μm or more to 1.5 mm or less.

4. The relief printing plate according to claim 1, wherein
said resin layer is of a water development type.

5. The relief printing plate according to claim 1, wherein
a surface of said metal support is covered with a layer comprising at least fluorine atoms.

6. The relief printing plate according to claim 1, wherein
said relief printing plate is a seamless plate.

7. The relief printing plate according to claim 1, wherein
said relief printing plate has a sleeve structure.

8. A print having a pattern of a coating liquid formed by a relief printing method using the relief printing plate according to claim 1.

9. A method for manufacturing an organic EL element, comprising:
printing a coating liquid in which a material for forming an organic light-emitting medium layer is dissolved or dispersed in a solvent on a printing substrate by a relief printing method using the relief printing plate according to claim 1, and forming an organic light-emitting medium layer.
